(19) United States
(12) Patent Application Publication
(10) Pub. No.: US 2020/0127244 A1
(43) Pub. Date: Apr. 23, 2020

(54) BATTERY CELL

(71) Applicant: Robert Bosch GmbH, Stuttgart (DE)

(72) Inventors: Florian Postler, Gundelsheim (DE); Johannes Bender, Bamberg (DE)

(21) Appl. No.: 16/627,416

(22) PCT Filed: Jun. 29, 2018
(86) PCT No.: PCT/EP2018/067685

§ 371 Date: Dec. 30, 2019

(30) Foreign Application Priority Data
Jun. 30, 2017 (DE) 10 2017 211 112.7

(51) Int. Cl. H01M 2/02; H01M 2/30

(52) U.S. Cl. CPC H01M 2/027; H01M 2/30; H01M 2/0287

(57) ABSTRACT

The invention relates to a battery cell (2), comprising a cell housing, in which an electrode unit (10) is arranged, wherein the electrode unit (10) has an anode, which is electrically connected to a negative terminal (11), and a cathode, which is electrically connected to a positive terminal (12), the cell housing having a first housing part (61), which forms the negative terminal (11), and a second housing part (62) which forms the positive terminal (12). The first housing part (61) is made of a hybrid material, comprising a first layer (81) made of copper and a second layer (82) made of aluminum.

### BACKGROUND OF THE INVENTION

The invention relates to a battery cell comprising a cell housing in which an electrode unit is arranged, wherein the electrode unit has an anode, electrically connected to a negative terminal, and a cathode, electrically connected to a positive terminal, and wherein the cell housing has a first housing part that forms the negative terminal and a second housing part that forms the positive terminal.

Electrical energy can be stored using batteries. Batteries convert chemical reaction energy into electrical energy. A distinction is made here between primary batteries and secondary batteries. Primary batteries are functional only once, while secondary batteries, also referred to as rechargeable batteries, are rechargeable. In particular, lithium ion battery cells, as they are known, are used in a rechargeable battery. They are characterized, among other things, by high specific energies, thermal stability and very low self-discharge.

Lithium ion battery cells have a positive electrode, also referred to as a cathode, and a negative electrode, also referred to as an anode. The cathode and the anode each comprise a current collector on which an active material is applied. The electrodes of the battery cell are embodied in the manner of a foil and wound to form an electrode winding or stacked to form an electrode stack having a plurality of electrode layers by interposing a separator that separates the anode from the cathode. The electrodes and the separator are surrounded by a generally liquid electrolyte.

A battery cell furthermore has a cell housing that consists for example of aluminum. The electrode unit is arranged inside the cell housing. The cell housing is for example prismatic, in particular cuboid, or circular cylindrical. Other structural forms for cell housings are also known.

The two electrodes of the electrode unit are electrically connected to poles of the battery cell, which are also referred to as terminals. The terminals of the battery cell can here be arranged on the cell housing and be electrically insulated from the cell housing. However, it is also conceivable that the cell housing has a first housing part, forming the negative terminal, and a second housing part, forming the positive terminal, with both housing parts being electrically insulated from one another.

DE 10 2011 076 919 A1 discloses a generic battery cell, having an electrode unit arranged in a metallic housing. The housing here comprises two housing parts which are electrically insulated from one another by way of an insulating element. The anode and the cathode of the electrode unit are electrically connected to in each case one of the two housing parts. The two housing parts thus form the terminals of the battery cell.

US 2014/0011074 A1 discloses lithium ion battery cells which are interconnected by way of connecting elements, in particular connected in series. The battery cells each have a prismatic cell housing in which an electrode unit is arranged. A positive terminal is formed in one piece with a cover of the prismatic cell housing. A negative terminal, which is made from a composite material, projects through an opening in the cover of the cell housing. The composite material for example comprises one layer made from copper, one layer made from aluminum, and one interposed layer made from nickel.

US 2015/0086867 A1 discloses a lithium ion battery cell having a prismatic cell housing in which an electrode unit is arranged. A positive terminal and a negative terminal each project through an opening in a cover of the cell housing. The negative terminal has a composite material, which comprises for example one layer made from copper and one layer made from aluminum.

### SUMMARY OF THE INVENTION

Proposed is a battery cell, in particular a lithium ion battery cell, which comprises a cell housing in which an electrode unit is arranged. The electrode unit here has an anode, electrically connected to a negative terminal, and a cathode, electrically connected to a positive terminal. The cell housing has a first housing part and a second housing part. The first housing part forms the negative terminal, and the second housing part forms the positive terminal.

According to the invention, the first housing part of the cell housing is made from a hybrid material, comprising a first layer made from copper and a second layer made from aluminum. The first layer made from copper and the second layer made from aluminum are here in particular electrically conductively interconnected. In this way, an electric current can flow from the first layer made from copper to the second layer made from aluminum, and in the opposite direction.

The hybrid material of the first housing part preferably comprises here exactly two layers, specifically the first layer made from copper and the second layer made from aluminum. The hybrid material of the first housing part thus preferably comprises no third layer.

The first layer of the hybrid material made from copper here preferably immediately adjoins the second layer of the hybrid material made from aluminum. In other words, in particular no intermediate layer is provided between the first layer and the second layer.

According to a preferred configuration of the invention, the anode of the electrode unit is connected to the first layer of the hybrid material made from copper. For example, the anode of the electrode unit and the first layer of the hybrid material made from copper are here integrally bonded together, in particular welded together. The anode here advantageously has a current collector made from copper which is integrally bonded, in particular welded, to the first layer of the hybrid material made from copper. In this way, materials of the same type can be welded together.

According to one advantageous configuration of the invention, the first housing part of the cell housing is arranged such that the first layer of the hybrid material made from copper faces the electrode unit, and that the second layer of the hybrid material made from aluminum faces away from the electrode unit. That means that the first layer of the hybrid material made from copper faces an interior of the cell housing, and the second layer of the hybrid material made from aluminum faces the outside.

The second housing part of the cell housing is preferably made from aluminum. In particular, the second housing part of the cell housing consists of aluminum, in other words has no further material. For example, the cathode of the electrode unit and the second housing part of the cell housing made from aluminum are here integrally bonded together, in particular welded together. The cathode advantageously here has a current collector made from aluminum that is integrally bonded, in particular welded, to the second housing part of the cell housing made from aluminum. In this way, materials of the same type can be welded together.

According to an advantageous development of the invention, an insulating element is provided which electrically insulates the two housing parts and thus also the two terminals from one another. At the same time, the insulating element seals off the interior of the cell housing from the outside, with the result that for example no electrolyte can leave the interior of the cell housing and that no humidity can enter the interior of the cell housing.

The electrode unit is here particularly advantageously held in the insulating element in a form-fitting manner. The insulating element thus fulfills yet another function.

The first housing part of the cell housing and the second housing part of the cell housing are particularly advantageously also held in the insulating element in a form-fitting manner. The insulating element thus fulfills yet another function.

A battery cell according to the invention is advantageously used in an electric vehicle (EV), in a hybrid vehicle (HEV), in a plug-in hybrid vehicle (PHEV), in a stationary battery, in particular for grid stabilization in households, in a battery in a marine application, for example in shipbuilding or in jet skis, or in a battery in an aeronautic application, in particular in aircraft construction. Further applications are also conceivable.

A battery cell according to the invention has a simplified and robust design. The number of the components that are required has advantageously also been reduced. An electric resistance between the electrodes and the terminals is advantageously reduced. Consequently, for example integration of a fast discharge device into the battery cell is possible. Space is saved within the cell housing, in particular also because the insulating element adopts several functions. The insulating element serves firstly to electrically insulate the electrodes, the connector elements and the housing parts of different polarity from one another. The insulating element also serves to receive and hold the connector elements and the housing parts in a form-fitting manner. The insulating element, similar to a conventional retainer, also serves to position the electrode unit within the cell housing. Furthermore, simplified integration of a plurality of battery cells into a battery module is possible. All battery cells in such a battery module have only terminals made from aluminum. Said terminals are therefore relatively easy to connect to one another, for example by welding.

### BRIEF DESCRIPTION OF THE DRAWINGS

Embodiments of the invention will be explained in more detail with reference to the drawings and the following description.

In the figures:

FIG. 1 shows a schematic sectional illustration of a battery cell,

FIG. 2 shows a perspective sectional illustration of a cell housing of the battery cell from FIG. 1, and

FIG. 3 shows a sectional illustration of a partial region of the battery cell from FIG. 1.

### DETAILED DESCRIPTION

In the following description of the embodiments of the invention, identical or similar elements are designated with the same reference signs, with repeated description of these elements being omitted in individual cases. The figures only schematically represent the subject matter of the invention.

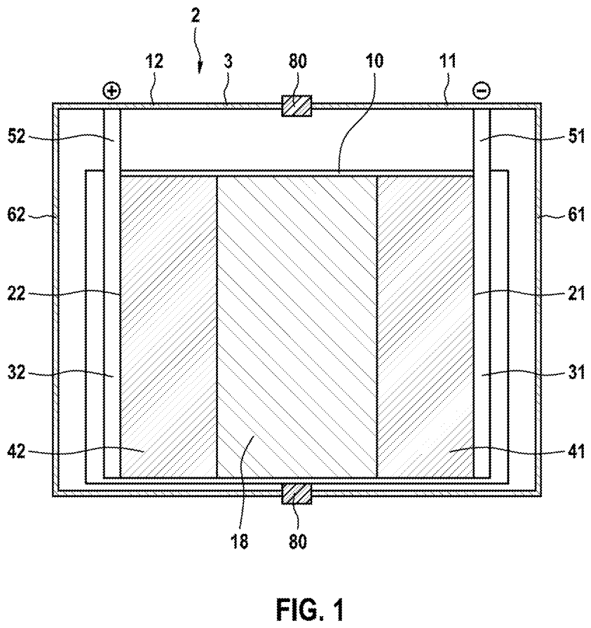

FIG. 1 shows a schematic sectional illustration of a battery cell 2. The battery cell 2 comprises a cell housing 3, which is embodied to be electrically conducting. The cell housing 3 has a first housing part 61 and a second housing part 62, which are electrically insulated from one another by a surrounding insulating element 80. The first housing part 61 forms a negative terminal 11, and the second housing part 62 forms a positive terminal 12. A voltage that is provided by the battery cell 2 can be tapped via the terminals 11, 12. The battery cell 2 can furthermore also be charged via the terminals 11, 12.

The first housing part 61 is made from a hybrid material, which in the present case comprises two metallic material layers. The second housing part 62 is made from aluminum in the present case. Consequently, both housing parts 61, 62 are electrically conductive.

An electrode unit 10, having two electrodes, specifically an anode 21 and a cathode 22, is arranged within the cell housing 3 of the battery cell 2. In the present case, the electrode unit 10 is embodied in the form of an electrode winding, and the anode 21 and the cathode 22 are in each case embodied in the manner of a foil and wound to form the electrode winding with interposition of a separator 18. It is likewise conceivable that the electrode unit 10 is configured as an electrode stack, wherein layers of the anode 21 and layers of the cathode 22 are stacked one above the other with the interposition of in each case one layer of the separator 18.

In the present case, a liquid electrolyte is provided in the interior of the cell housing 3 of the battery cell 2. The electrode unit 10 of the battery cell 2 having the anode 21, the cathode 22 and the separator 18 is surrounded by the liquid electrolyte.

The anode 21 comprises an anodic active material 41, which is embodied in the manner of a foil. The anode 21 furthermore comprises a current collector 31, which is likewise embodied in the form of a foil. The anodic active material 41 and the current collector 31 of the anode 21 are placed flat one on top of the other and connected together. Consequently, the anode 21 is also embodied in the manner of a foil.

The cathode 22 comprises a cathodic active material 42, which is embodied in the manner of a foil. The cathode 22 furthermore comprises a current collector 32, which is likewise embodied in the manner of a foil. The cathodic active material 42 and the current collector 32 of the cathode 22 are placed flat one on top of the other and connected together. Consequently, the cathode 22 is also embodied in the manner of a foil.

The current collector 31 of the anode 21 is embodied to be electrically conductive and is made from a metal, for example copper. Anode contact tabs, which are electrically connected to a negative connector element 51, project away from the current collector 31 of the anode 21. The negative connector element 51 is electrically connected to the first housing part 61. Consequently, the anode 21 is electrically connected to the negative terminal 11 of the battery cell 2 via the negative connector element 51. Alternatively, the anode contact tabs can also be connected directly to the first housing part 61. The negative connector element 51 is not necessary in that case.

The current collector 32 of the cathode 22 is embodied to be electrically conductive and made from a metal, for example from aluminum. Cathode contact tabs, which are electrically connected to a positive connector element 52, project away from the current collector 32 of the cathode 22. The positive connector element 52 is electrically connected to the second housing part 62. Consequently, the cathode 22 is electrically connected to the positive terminal 12 of the battery cell 2 via the positive connector element 52. Alternatively, the cathode contact tabs can also be connected directly to the second housing part 62. The positive connector element 52 is not necessary in that case.

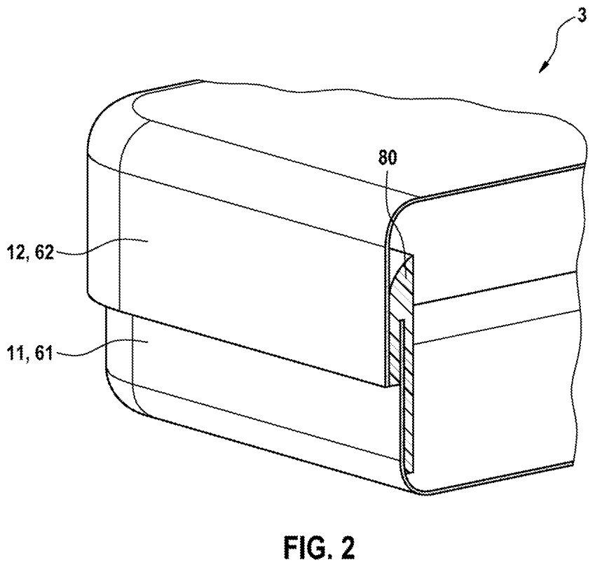

FIG. 2 shows a perspective sectional illustration of a cell housing 3 of the battery cell 2 from FIG. 1. The electrode unit 10 of the battery cell 2, which is located in the interior of the cell housing 3, is not shown here.

The first housing part 61, which forms the negative terminal 11, and the second housing part 62, which forms the positive terminal 12, are electrically insulated from one another by way of the surrounding insulating element 80. The insulating element 80 also serves to seal off the interior of the cell housing 3 from the outside, such that in particular no electrolyte can leave the interior of the cell housing 3 and that no humidity can enter the interior of the cell housing 3.

The first housing part 61 of the cell housing 3 and the second housing part 62 of the cell housing 3 are held in the insulating element 80 in a form-fitting manner.

The insulating element 80 in the present case is adhesively bonded to the first housing part 61 and to the second housing part 62.

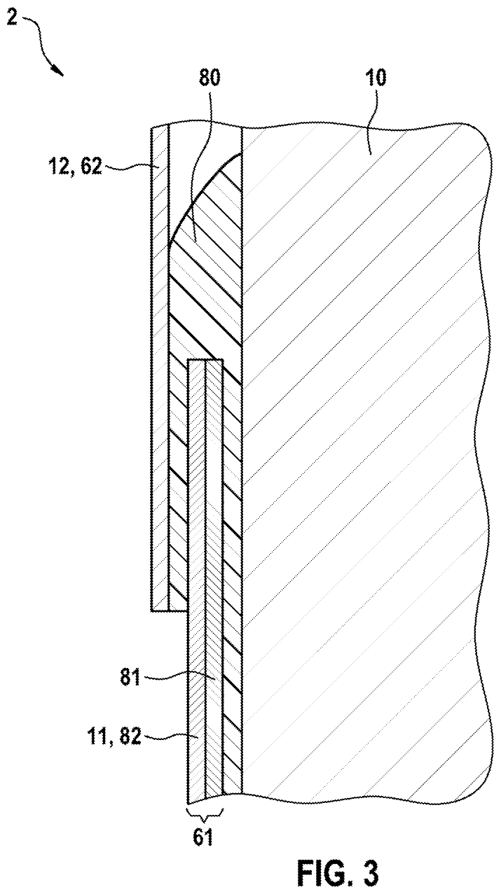

FIG. 3 shows a sectional illustration of a partial region of the battery cell 2 from FIG. 1. The electrode unit 10 of the battery cell 2, which is located in the interior of the cell housing 3, adjoins the insulating element 80 and is held in the insulating element 80 in a form-fitting manner.

The first housing part 61 is made from a hybrid material, comprising a first layer 81 made from copper and a second layer 82 made from aluminum. The first layer 81 of the hybrid material made from copper immediately adjoins the second layer 82 of the hybrid material made from aluminum.

The first housing part 61 of the cell housing 3 is arranged such that the first layer 81 of the hybrid material made from copper faces the electrode unit 10. The second layer 82 of the hybrid material made from aluminum faces away from the electrode unit 10. The first layer 81 of the hybrid material made from copper thus faces the interior of the cell housing 3. The second layer 82 of the hybrid material made from aluminum faces the outside, that is to say away from the electrode unit 10 in the interior.

The anode 21 of the electrode unit 10 is connected to the first layer 81 of the hybrid material made from copper that is located inside. The anode 21 of the electrode unit 10 and the first layer 81 of the hybrid material made from copper, which faces inwardly, are here integrally bonded to one another, in particular welded together.

The invention is not limited to the exemplary embodiments described here and the aspects highlighted therein. Rather, a large number of modifications that lie within technical expertise are possible within the scope given by the claims.

Please amend the listing of claims as follows:

1. A battery cell (2) comprising a cell housing (3) in which an electrode unit (10) is arranged, wherein the electrode unit (10) has an anode (21), electrically connected to a negative terminal (11), and a cathode (22), electrically connected to a positive terminal (12), wherein the cell housing (3) has a first housing part (61) that forms the negative terminal (11) and a second housing part (62) that forms the positive terminal (12), characterized in that the first housing part (61) is made from a hybrid material comprising a first layer (81) made from copper and a second layer (82) made from aluminum.

2. The battery cell (2) as claimed in claim 1, characterized in that the hybrid material of the first housing part (61) comprises exactly two layers (81, 82).

3. The battery cell (2) as claimed in claim 1, characterized in that the first layer (81) immediately adjoins the second layer (82).

4. The battery cell (2) as claimed in claim 1, characterized in that the anode (21) is connected to the first layer (81).

5. The battery cell (2) as claimed in claim 1, characterized in that the first housing part (61) is arranged such that the first layer (81) faces the electrode unit (10) and that the second layer (82) faces away from the electrode unit (10).

6. The battery cell (2) as claimed in claim 1, characterized in that the second housing part (62) is made from aluminum.

7. The battery cell (2) as claimed in claim 1, further comprising an insulating element (80) which electrically insulates the housing parts (61, 62) from one another.

8. The battery cell (2) as claimed in claim 7, characterized in that the electrode unit (10) is held in the insulating element (80) in a form-fitting manner.

9. The battery cell (2) as claimed in claim 8, characterized in that the first housing part (61) and the second housing part (62) are held in the insulating element (80) in a form-fitting manner.

10. (canceled)

11. The battery cell (2) as claimed in claim 1, characterized in that the hybrid material of the first housing part (61) comprises exactly two layers (81, 82), wherein the first layer (81) is made from copper and the second layer (82) is made from aluminum.

12. An electric vehicle (EV) comprising a battery cell as claimed in claim 1.

13. A hybrid vehicle (HEV) comprising a battery cell as claimed in claim 1.

14. A plug-in hybrid vehicle (PHEV) comprising a battery cell as claimed in claim 1.

15. A stationary battery comprising a battery cell as claimed in claim 1.

16. A battery in a marine application comprising a battery cell as claimed in claim 1.

17. A battery in an aeronautic application comprising a battery cell as claimed in claim 1.
